(19) United States
(12) Patent Application Publication
(10) Pub. No.: US 2008/0246416 A1
(43) Pub. Date: Oct. 9, 2008

(54) PROCESS AND APPARATUS FOR IMPROVED LED PERFORMANCE

(76) Inventors: Dale G. Jones, San Luis Obispo, CA (US); Barbara L. Marcum, San Luis Obispo, CA (US); Yao Youda, Shantou (CN)

Correspondence Address: KLEIN, O'NEILL & SINGH, LLP, 43 CORPORATE PARK, SUITE 204, IRVINE, CA, 92606, US

(21) Appl. No.: 12/140,871

(22) Filed: Jun. 17, 2008

Related U.S. Application Data
(62) Division of application No. 10/947,775, filed on Sep. 22, 2004.
(60) Provisional application No. 60/504,196, filed on Sep. 22, 2003.
(60) Provisional application No. 60/512,706, filed on Oct. 21, 2003.

(51) Int. Cl. H05B 41/36; H05B 37/00; H01M 10/44

(52) U.S. Cl. 315/294; 315/312; 320/101

(57) ABSTRACT

Process and apparatus for improving LED performance are disclosed in which, in one exemplary embodiment, a lamp having one or more LEDs is powered by at least one rechargeable battery that may be recharged by solar photovoltaic panel or any number of DC or AC power sources, including a car battery or household AC outlets. The power to illuminate the LEDs from the rechargeable battery is regulated by a control circuit that enables the LEDs to illuminate for at least twice the operating time for the same LEDs and the same rechargeable battery without the control circuit.

### CROSS-REFERENCE TO RELATED APPLICATIONS

This application claims priority to application Ser. No. 10/947,775, filed on Sep. 22, 2004 which is an ordinary application of provisional application Ser. No. 60/504,196, filed Sep. 22, 2003, and of provisional application Ser. No. 60/512,706, filed Oct. 21, 2003, their contents are expressly incorporated herein by reference as if set forth in full.

Process and apparatus for improving performance of light emitting diodes are generally discussed herein with particular discussion extended to process and apparatus for improving performance of light emitting diodes mounted in portable spotlights.

### BACKGROUND

Light-emitting diodes, or LEDs, are becoming increasingly popular for providing illumination in such widely varied uses as traffic signals, hand-held electronic devices and electronic message boards. LEDs provide illumination with an electrical energy requirement typically about 90% less compared with conventional incandescent light bulbs. LEDs also have an operating lifetime typically more than about 10 years. LEDs of various visible colors such as red, amber, green or white typically operate at direct current (DC) voltages from 2.2 to 4.5 volts. The LEDs may be connected in parallel so that if any of the LEDs should fail, the remaining LEDs continue to operate without difficulty.

Because they operate at relatively low voltage levels, LEDs are well suited for use with a solar photovoltaic panel, where a relatively small number of series-connected solar cells can provide sufficient voltage for powering the LEDs. Typically, such a solar panel is used to recharge a relatively small number of series-connected rechargeable battery cells during day light, so that the LEDs can then operate at night or in dark conditions to provide light when there is no electrical power being provided from the solar panel. LEDs may also be powered from fuel cells, where a relatively small number of stacked fuel cell layers connected in series will provide sufficient voltage for LED operation.

To enhance the usefulness of LEDs for a variety of lighting purposes, means for controlling the current supplied to a number of parallel-connected LEDs from a variety of suitable power sources is a desirable objective. Batteries typically lose voltage as electrical energy is consumed by the LEDs, so a means of adjusting tire battery power supply to extend the operating lifetime of the LEDs over a wide range of battery DC supply voltages is an important requirement. Even if the battery voltage could be controlled at a fixed level, this would not provide an acceptable means for powering the LEDs. Among other things, each LED is ranked according to forward voltage. The forward voltages for the same type of LEDs can vary by ±20% or more. If the forward voltage of any specific LED is exceeded by as little as +5%, that LED can quickly burn out because the current through the LED increases exponentially as forward voltage increases only slightly.

Most electronic devices, such as light bulbs, electric motors and household electric appliances, etc. are designed to be supplied with a fixed supply voltage, such as 120 VAC. However, as described above, LEDs cannot be properly operated based solely upon the supply of a fixed DC voltage.

Accordingly, there is a need for efficient means of controlling the DC current supplied to one or more parallel-connected LEDs using a control circuit that protects the LEDs from excessive current at high DC supply voltages and that extends the duration of useful LED light output as battery capacity is drained during continuous operation of the LEDs which are being powered from a battery.

Power supply sources considered herein include batteries, such as rechargeable batteries which can be recharged using optional sources of electrical power supply, such as a solar photovoltaic panel, AC power sources, DC power sources, or fuel cells, which can be recharged with some form of hydrogen, such as gaseous hydrogen or hydrogen supplied in other forms, such as methanol as in the direct methanol (DMFC) fuel cell process.

Solar photovoltaic panels typically utilize mono-crystalline or multi-crystalline silicon cells connected in series to obtain sufficiently high voltages for efficient charging of a battery. Electric energy can then be withdrawn from the battery to provide electrical power supply to a number of parallel-connected LEDs.

### SUMMARY

Aspects of the present invention include methods whereby a number of parallel-connected light-emitting diodes, or LEDs, are operated from a control circuit which is provided with electrical energy from a rechargeable battery, a fuel cell, or an external power source. In general terms, embodiments provided in accordance with aspects of the present invention enable one or more such parallel-connected LEDs to operate for at least twice as long as the same LEDs connected directly to the same battery, but without the benefit of the control circuits described herein.

In one aspect of the present invention, a control circuit minimizes the current supplied to the LEDs at higher DC power supply voltages and extends the duration of useful LED light output as the battery capacity is drained during continuous operation of the LEDs. In one preferred embodiment, the control circuit includes components for efficiently boosting the variable battery voltage to a consistent DC output voltage, and/or components for charging the battery from a variety of sources, such as a solar photovoltaic panel, an AC current power source, or DC current power sources including batteries or fuel cells. In another preferred embodiment, a photocell sensor is used to turn on the LEDs at night or in dim ambient lighting conditions and to otherwise turn off the LEDs. In other preferred embodiments, methods for mounting and waterproofing the LEDs are described. In still other preferred embodiments, methods are described for utilizing various LED power sources in combination with various converters to provide useful output power. Test results illustrating the usefulness of various embodiments provided in accordance with aspects of the present invention are also described.

In one preferred embodiment, the battery is a rechargeable battery suitably connected to a solar photovoltaic panel, which recharges the battery during the daytime when there is adequate ambient light intensity. The battery can then be used to operate a number of parallel-connected LEDs, thereby providing lighting as desired during night or in dim ambient light conditions. In another preferred embodiment, a photocell sensor can be used to detect night or dim lighting conditions and subsequently energize one or more parallel-connected LEDs. Other types of sensors could optionally be used to provide the on-off control for the LEDs based on the intensity of the ambient lighting. Exemplary sensors useable in the apparatus of the present invention include photo-resistive cells, photodiodes, phototransistors, photothyristors, and light-activated silicon-controlled rectifiers (LASCRs).

In one exemplary embodiment, a control circuit provided in accordance with aspects of the invention is preferably located between the battery (or other equivalent power source) and the LEDs. One preferred function of the control circuit is to regulate the current supplied to the LEDs over a relatively wide range of power supply voltages. In another preferred embodiment, the control circuit can be used if the power supply system consists of a fuel cell, such as a DMFC micro fuel cell, an external AC power source, such as 120 VAC, or an external DC power source, such as 12 VDC, rather than a battery which can be recharged during daylight hours using a solar photovoltaic panel or other means.

### BRIEF DESCRIPTION OF THE DRAWINGS

These and other features and advantages of the present invention will become appreciated as the same become better understood with reference to the specification, claims and appended drawings wherein:

FIG. 1 is a semi-schematic partial cross-sectional view of an exemplary LED light incorporating a control circuit provided in accordance with aspects of the present invention to power a plurality of LEDs;

FIG. 2A is a semi-schematic semi-perspective view of the LED light of FIG. 1 with optional accessory items (FIGS. 2B & 2C);

FIG. 3 is a control circuit arrangement for testing transistor selection effects provided in accordance with aspects of the present invention;

FIG. 4 is a graph depicting the effect of transistor selection on LED performance;

FIG. 5 is a control circuit tested with a single Luxeon white LED;

FIG. 6 is a graph depicting current vs. voltage with and without control circuit for a single Luxeon white LED;

FIG. 7 is a control circuit arrangement for operating parallel-connected LEDs;

FIG. 8 is a graph depicting the effect of a control circuit provided in accordance with aspects of the present invention on LED current consumption;

FIG. 9 is a graph depicting the effect of a control circuit provided in accordance with aspects of the present invention on battery-operated LEDs;

FIG. 10A is a control circuit arrangement for providing a regulated DC voltage output and FIG. 10B shows efficiency curves versus current demand for various levels of battery supply voltage for the device of FIG. 10A;

FIG. 11 combines three semi-schematic views of an exemplary physical arrangement of a plurality LEDs in a miniature LED light; and

FIG. 12 is a control circuit of an optional power supply configuration.

### DETAILED DESCRIPTION

The detailed description set forth below in connection with the appended drawings is intended as a description of the presently preferred process and apparatus for improving LED performance provided in accordance with the present invention and is not intended to represent the only forms in which the present invention may be constructed or utilized. The description sets forth the features and the steps for constructing and using the process and apparatus for improving LED performance of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

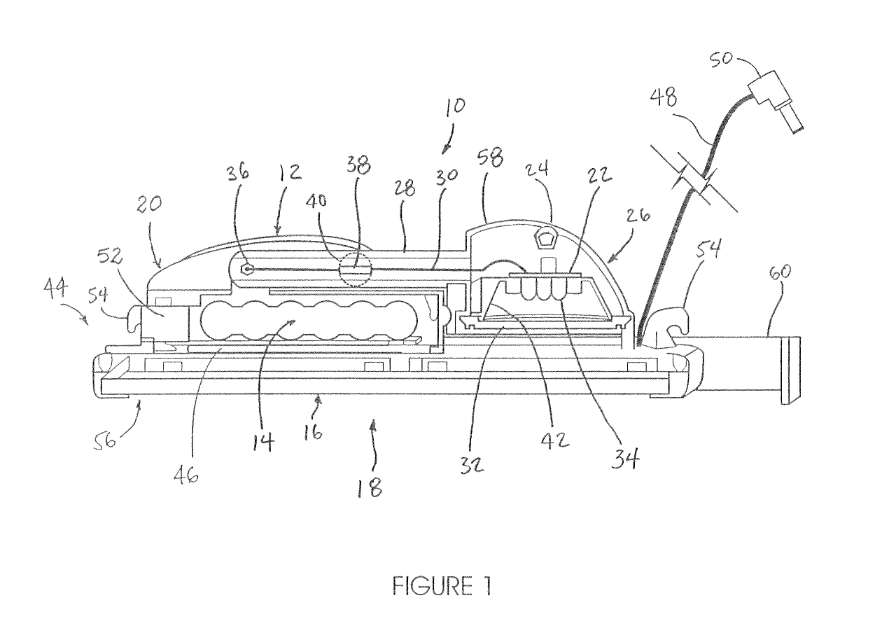

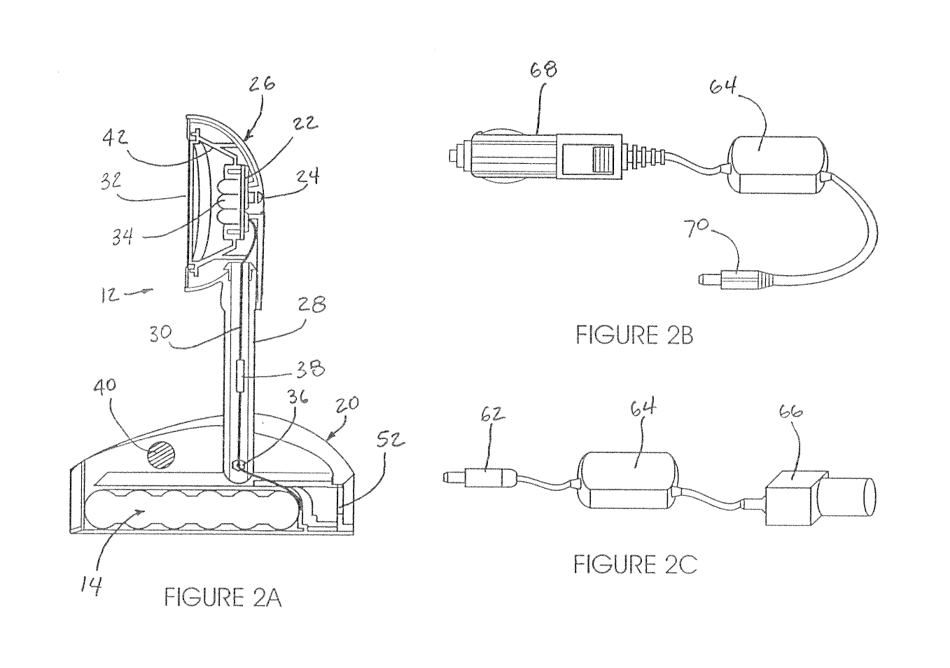

In one exemplary embodiment, an assembly provided in accordance with aspects of the present invention comprises a solar panel and a detachable portable LED lamp, which contains at least one rechargeable battery, a control circuit that regulates the current supplied to the LEDs front the at least one rechargeable battery, a photocell sensor for turning the LEDs on at night or in dim lighting conditions, and a number of parallel-connected LEDs. An exemplary physical configuration of the one embodiment is shown in FIG. 1. The portable LED lamp of FIG. 1 without the solar panel is shown in FIG. 2A and optional accessory items are shown in FIGS. 2B and 2C. It should be noted that the embodiment of the control circuit described below is with the control circuit mounted on a printed circuit board (PCB). However, since the portable LED lamp can optionally be connected with a variety of accessory items, these accessory items are considered to be an associated part of the control circuit, although they might not necessarily be physically located on the PCB-mounled control circuit mentioned in the description below.

Referring now to FIG. 1, a lamp assembly incorporating the circuits and the process provided in accordance with aspects of the present invention is shown, which is generally designated 10. The lamp assembly 10 comprises a lamp or spotlight 12 comprising at least one rechargeable battery 14 and a photovoltaic panel 16. In operation, sunlight 18 impinges on the solar photovoltaic panel 16 to recharge the battery 14. The battery 14 is contained within the base 20 of the portable lamp 12 and supplies electrical energy to the PCB-mounted control circuit 22, which is regulated by a photocell sensor 24 located at the back side 58 of the LED lamp head 26. The lamp head 26 is connected to the lamp base 20 by way of an elongated arm 28. Thus, in present embodiment, the housing comprises a combination lamp head, lamp base, and elongated arm. In one exemplary embodiment, the elongated arm 28 comprises a hollow cylindrical tube containing electric wires 30 for electrically coupling the battery 14 to the PCB 22. In one exemplary embodiment, the lamp base 20 comprises a generally rectangular box comprising a removable plate fastened to the generally rectangular box, using fasteners and detents, for accessing the interior of the base. The lamp base 20 incorporates a slot or channel for receiving the elongated arm 28 to enable the elongated arm to fold and the lamp to collapse into a generally flat profile as shown in FIG. 1 (as compared to an un-fold configuration shown in FIG. 2A). An optional mounting flange or hook may be molded to the plate or the generally rectangular box for mounting the lamp 12 on a wall or other surfaces. Moisture is prevented from entering the lamp head by means of a rubber plug or other flexible material placed inside the hollow lamp arm 28. The lamp arm 28 may be made from nylon plastic, but other plastic materials such as polycarbonate or high impact ABS plastic could also be used. The lamp base and other plastic parts can be made from less expensive plastic such as ABS plastic with ultraviolet inhibitor to provide protection during long term sunlight exposure.

In one exemplary embodiment, the lamp head 26 is constructed to be waterproof or water resistant by sealing a front lens 32 against the perimeter of the lamp head opening. One preferred method of providing a waterproof seal is by forcing front lens 32 against an O-ring located in a recessed groove at the front perimeter of the lamp head opening. Waterproofing the lamp head or making it water resistant prevents malfunction of the control circuit 22 due to moisture which would otherwise corrode or damage the control circuit connections. The front lens 32 is preferably transparent or translucent to allow light emanating from one or more LEDs 34 to pass through the front lens 32, as desired for illumination purposes. Similar to conventional flashlights, a plurality of LEDs 34 may be mounted inside a reflective housing 42.

In one exemplary embodiment, the elongated arm 28 is configured to rotate on axle hubs 36 located inside the lamp base 20, which allow lamp head 26 to be lifted up or folded down as desired to adjust the angle of illumination being provided by LEDs 34. The lamp arm 28 is preferably formed with a “T” shape to provide an axle at one end, which allows the preferred up and down motion of the lamp head 26 when the lamp arm 28 is mounted in the axle hubs 36. A magnetic reed switch 38 disconnects the battery 14 from the control circuit 22 whenever the elongated arm 28 is rotated down into its closed position (as shown). In this closed position, the magnetic reed switch 38 comes into close proximity with a magnet 40 mounted inside the lamp base 20, which opens the normally-closed magnetic reed switch 38.

At night or in dim lighting conditions, the photocell sensor 24 allows the control circuit 22 to provide regulated DC current to the one or more LEDs 34, which are positioned inside the reflector housing 42. The LEDs 34 are suitably mounted on the printed circuit board (PCB) 22, which contains the control circuit. The PCB 22 is suitably attached to and mechanically supported by the reflector housing 42. The LEDs 34 therefore provide output light at night or in dim lighting conditions, provided of course the elongated arm 28 is rotated by lifting lamp head 26 up, to close the magnetic reed switch 38 and energize the LEDs 34.

As is readily apparent to a person of ordinary skill in the art, the LED lamp assembly with the control circuit 22 may be practiced without using the photocell sensor 24. In that instance, the LEDs 34 will illuminate whenever the reed switch 38 closes irrespective of the intensity of the ambient lighting conditions.

FIG. 1 shows all the system components with the portable LED lamp 12 mounted to the back side 44 of solar panel 16 using suitable tracks 46 on the inactive side of the panel, which allow the lamp base 20, incorporating corresponding tracks on the removable plate, to slide in or out of the tracks 46. In this way, the system components can be stored or configured in a compacted arrangement to save space. The solar panel 16 provides electric energy for recharging the at least one battery 14 through the power cord 48, which terminates in a suitable DC power plug 50 that can optionally be connected with a mating DC jack 52 located in the lamp base 20. In one exemplary embodiment, nickel-metal hydride (NiMH) “AA” batteries, (connected in 3-cell series arrangements with a preferred nominal voltage of 3.6 VDC) are used to power the LEDs 34. The power cord 48 is normally wrapped around the periphery of the solar panel 16 using the hooks 54 located at the back side 44 of the solar panel 16 at each of the four corners of the solar panel 16. However, fewer than four or more than four hooks 54 may be used without deviating from the scope of the present invention.

If the power cord 48 is unwrapped from the hooks 54 and the lamp 12 is removed from the tracks 46, then the solar panel 16 can be located at a distance from the lamp assembly 12 while still providing electric energy for recharging the battery 14 during daylight hours when ambient light 18 impinges on the active surface 56 of the solar panel 16. The entire assembly 10 can therefore operate automatically over a period of many years without any electrical connection to external sources of electrical power while still providing LED output light during night or in dim ambient lighting conditions as detected by the photocell sensor 24 located at the back side 58 of the lamp head 26, opposite the front lens 32.

In one exemplary embodiment, a mounting bracket 60 is provided as part of the solar panel 16 to facilitate convenient mounting or positioning of the solar panel 16. The mounting bracket 60 is generally U-shape in configuration and pivotally connects to the panel at the two ends of the U. If the U-shape bracket 60 is pivoted away from the panel 16 and rested against a flat horizontal surface, a secure and stable A-shape framework is thereby formed between the U bracket 60, the solar panel 16 and the horizontal surface which facilitates solar energy capture onto the active surface of the solar panel 16 when pointed towards sunlight 18. The A-frame permits the solar panel 16 to be aimed in a direction towards the greatest sun light intensity, which is generally towards the direction of the South Pole (for operating locations in the Northern hemisphere) or the North Pole (for operating locations in the Southern hemisphere). Another preferred mounting method is to fasten the U-shape bracket 60 to a roof, fence or wall using nails or screws, and then orienting the solar panel for best solar energy capture by locking down thumbscrews or other means of connecting the panel at the two ends of the U.

FIG. 2A is a semi-schematic partial cross-sectional partial perspective view of the lamp 12 of FIG. 1 shown with several optional accessory items in FIGS. 2B and 2C. As shown in FIG. 2A, the at least one rechargeable battery 14 provides electrical energy to the PCB-mounted control circuit 22 located inside the lamp head 26 via wires 30 running inside the elongated lamp arm 28. As previously described, the battery 14 is disconnectable from the PCB-mounted control circuit 22 by the magnetic switch 38, activated when the lamp arm 28 is folded downwards towards the magnet 40 mounted inside the lamp base 20. The lamp base 20 also includes a DC jack 52, which is connected to the battery 14.

To make use of one of the optional accessory items, a DC plug 62 (FIG. 2C) may be inserted into the DC jack 52 located at the lamp base 20 to provide electrical energy from the battery 14 to a DC converter 64. The output of the DC converter 64 is provided to an output connector 66, which may then be used to connect to another adaptor or to a device for consuming power from the at least one battery 14. As shown in FIG. 2C, one exemplary output connector 66 is a 12 VDC female cigarette adapter, which can be used to provide 12 VDC power to a variety of optional devices.

Other accessory items useable with the lamp 12 include using DC converters 64 suitable for charging the at least one battery 14 from external sources of electrical power. As already described, one preferred embodiment uses a solar photovoltaic panel 16 for charging the at least one battery 14 (FIG. 1). Other sources of external electrical power include direct current power sources, such as 12 VDC (as in cars or boats) or alternating current power sources, such, as 120 VAC (as in standard residential wall sockets). If there is no sunlight, or if it is desired to rapidly charge the at least one battery 14 from an external source of electrical power, then a DC converter 64 is typically required to bring the external electrical power to the correct DC voltage level, thereby avoiding overcharging the at least one battery 14. In one exemplary embodiment, connection to an external source of electrical energy is provided by a power source connector 68 FIG. 2B). An example of a power source connector 68, as shown in FIG. 2B, consists of a male 12 VDC cigarette adapter. The cigarette adapter is connected to a DC converter 64 to enable charging the battery 14 located inside the lamp base 20 with a battery charging input connector 70, which is configured to connect to the DC jack 52 located in the lamp base 20. As is readily apparent to a person of ordinary skill in the art, rather than a cigarette adapter, a 2-prong or a 3-prong plug may be incorporated if the external power to be used for charging the battery 14 is an alternating current power source, such as 120 VAC.

The optional accessory items described herein are not physically located on the PCB control circuit 22 but may be connected to the control circuit using the DC jack 52 and are considered as part of the control circuit of the present invention. As portability is one advantage of the lamp assembly 10 of the present invention, the control circuit 22 provided in accordance with aspects of the present invention should therefore be able to operate with various accessory devices, which enable the control circuit 22 to operate in a variety of different modes as described herein.

Suitable connectors considered to be preferred embodiments of the present invention include but are not limited to the following list of both output accessory devices (“OADs” for providing electrical power from the battery to various electronic devices) as well as input accessory devices (“IADs” for charging the battery from various types of external sources of electrical power). The list includes:
1. Female 12 VDC cigarette adapter, with 12 VDC output from the DC converter 64 for use with cellular telephone chargers, cellular telephones, or other devices such as water pumps, portable computers, air fans, or other electrical devices which require 12 VDC electrical power as typically provided in motorized vehicles such as automobiles or boats.
2. Male adapters, typically providing 5 VDC output from the DC converter 64 for use with a variety of hand-held electronic devices, including but not limited to audio equipment, such as Sony Walkman and AM/FM radios, electronic game equipment, such as Nintendo Game Boy, personal desktop assistant (PDA) devices, such as the Palm Pilot, and other similar hand-held electronic devices. Since this list includes a large variety of such devices, there are also a variety of DC power ports located on these devices. To accommodate this variety, a preferred embodiment of the present invention includes a variety of DC power plugs provided in a kit form with a male adapter. For example, the DC power plugs in one preferred embodiment of such a kit would include, but not be limited to, the following list:
   a. 2.1×5.5 mm DC power plug
   b. 2.5×5.5 mm DC power plug
   c. 1.7×4.8 mm DC power plug
   d. 1.3×3.4 mm DC power plug
   e. 2.5 mm mono plug normally used for audio
   f. 3.5 mm mono plug normally used for audio
   g. RCA plug normally used for video
3. Male 12 VDC cigarette adapter 68 with a different style of DC converter (similar to DC converter 64) to provide DC power at a voltage level suitable for charging the battery, 14 through the input connector 70, which may be a DC power plug.
4. 120 VAC wall socket power adapter that converts AC power from the electricity grid to DC power at a voltage level suitable for charging the battery through an input connector.

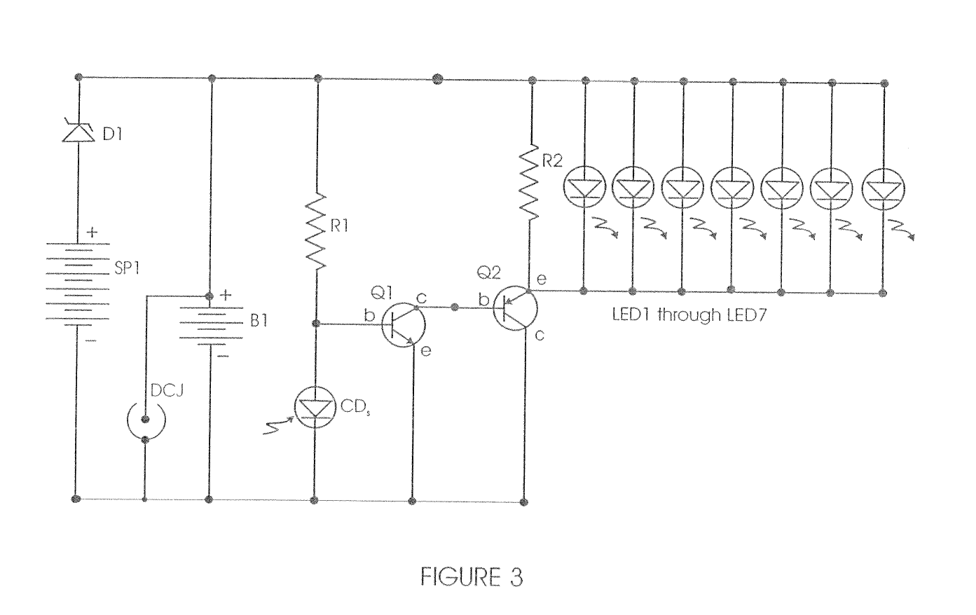

FIG. 3 provides a detailed circuit diagram for one embodiment of the control circuit provided in accordance with aspects of the present invention. This embodiment of the control circuit was used to evaluate the effect of transistor selection on the performance of 7 pcs of parallel-connected 5 mm white LEDs. The control circuit components were arranged as shown in FIG. 3 and included the various circuit elements described in Table 1, shown below.

TABLE 1
Components Used in the Control Circuit for Testing
Transistor Selection Effects

| Component | Description | Rating or Type |
|---|---|---|
| R1 | 47K | ½ Watt |
| R2 | 10K | ½ Watt |
| D1* | 1N5817 | Schottky Diode |
| Q1** | 2N2222 | NPN Transistor |
| Q2 | BD136 | PNP Transistor |
| CDs | 1K to 20 Meg | Cadmium Sulfide Photocell |
| B1 | NiMH Battery | 3.6 VDC @ 1500 mAh |
| DCJ | 2.1 × 5.5 mm | Center positive DC Jack |
| SP1*** | Solar Panel | Max. 6.8 VDC @ 250 mA |

*NOTE: 2pcs of 1N5817 can be connected in parallel to reduce the overall forward voltage drop.
**NOTE: Surface-mount equivalent transistor, P/N MMBT2222LT1-D can be substituted
***NOTE: Optional Solar Panel for Battery recharging (recharging can also be done with DC Jack)

The resistors R1 and R2 are conventional carbon-film resistors. The Schottky diode D1 has a low forward voltage drop value to minimize the voltage drop penalty from the solar panel output voltage to the battery thereby assuring that more solar energy can be used to recharge the nickel-metal hydride battery B1. The Schottky diode D1 prevents the battery B1 from discharging backwards through the solar panel SP1 at night or in dim lighting conditions. The transistor Q1 acts in combination with cadmium sulfoselenide (cadmium sulfide) photocell sensor CDs and resistor R1 to provide on-off LED switching control so that the LEDs will automatically turn on at night and off in daytime.

At night, the resistance of the photocell is very high, i.e. about 20 meg-ohms, which causes the base voltage of the NPN transistor Q1 to be high and the output at the collector of the switching transistor Q1 to be high, which provides a high voltage to the base of the PNP control transistor Q2 so that the emitter output from the transistor Q2 can turn on, which then causes the parallel-connected LEDs to be turned on at night. During the daytime, the process is reversed, i.e. the resistance of the photocell is very low, i.e. about 1 K-ohms, which causes the base voltage of the NPN transistor Q1 to be low and the output at the collector of the switching transistor Q1 to be low, which provides a low voltage to the base of the PNP control transistor Q2 so that the emitter output from the transistor Q2 can turn off, which then causes the parallel-connected LEDs to be turned off during the daytime.

Battery B1 contains 3 pcs of nickel-metal hydride (NiMH) “AA” size batteries each rated 1.2 VDC @1500 mAh, connected in series to provide a battery pack rated at 3.6 VDC @1500 mAh. These batteries can be recharged hundreds of times and the typical battery lifetime is about 5 years.

The solar photovoltaic panel SP1 comprises 12 pcs of mono-crystal line silicon cells arranged in a 1×12 array that can provide a maximum full sunlight rating of 6.8 VDC @250 mA output. The surface of the solar panel is covered with glass or other suitable transparent substance, such as Tefzel® or Tedlar®, weather and ultraviolet-resistant plastic materials offered by the DuPont Company. The transparent covering is permanently bonded to the solar cells using ethyl vinyl acetate (EVA, or “hot glue”) or clear-setting epoxy compound to provide a waterproof and electrically-insulated protective and transparent coating over the solar cells. The solar cells themselves are mounted to a suitable substrate, such as fiberglass FR4, to provide mechanical strength and electrical insulation. When finished, the flat monolithic solar panel assembly contains the solar cells sandwiched and between protective layers, including a transparent layer in front and a mechanically-strong layer in back.

Turning now to the control transistor Q2 used in the circuit of FIG. 3, it can be seen that the PNP control transistor has its emitter and collector terminals connected in series with a suitable load resistor R2 across the power supply terminals. Each system of one or more parallel-connected LEDs is then connected in parallel with the load resistor R2. As previously described, the PNP control transistor Q2 and, subsequently, the LEDs are turned on at night and off in daytime by the NPN switching transistor Q1, which is controlled by the photocell sensor-CDs.

Experiments were conducted to evaluate the effects of control transistor selection on the performance of the parallel-connected LEDs. The benefits of the control circuit were also compared with operating the same LEDs from the same battery, but without the control circuit. In these tests, the same LED configuration was used, i.e. 7 pcs of parallel-connected 5 mm white LEDs, with a light output rating of about 42,000 millicandella at 20 degree viewing angle, with a rated maximum current of 140 mA. For purposes of evaluating the LED light output, it was determined that at above about 14 mA (10% of maximum current), the LED light output was considered sufficient to be useful for practical purposes. Thus, 14 mA was used as the threshold for the tests.

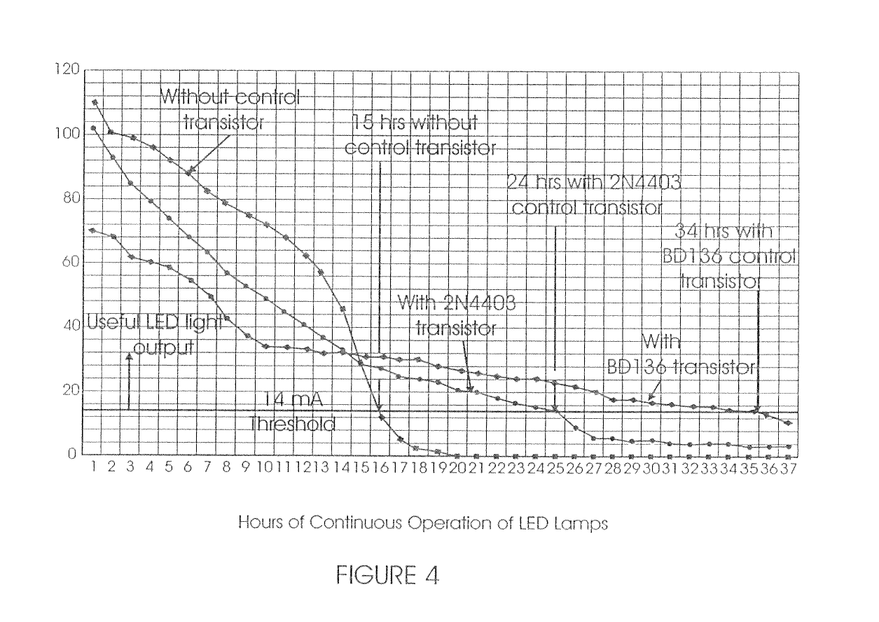

For these tests, the 3.6 VDC NiMH battery pack rated at 1500 mAh was fully charged to the same initial condition. FIG. 4 shows the effects of operating the parallel-connected LEDs with two different types of PNP control transistors as well as without any control circuit. The area under the three curves in FIG. 4 is the same, i.e. about 1200 mAh, or about 80% of maximum battery capacity. This shows that the three tests were conducted under the same initial battery charge conditions, using the same electrical load represented by the 7 pcs of parallel-connected LEDs.

The results of these comparison tests are shown in FIG. 4, where it is immediately seen that the PNP type BD136 control transistor Q2 used in the control circuit provided in accordance with aspects of the present invention allowed the LEDs to operate continuously for 34 hours above the 14 mA useful light output criterion, while the same LEDs operated for 24 hours with the PNP type 2N4403 control transistor, but only for 15 hours without the benefit of the control circuit. It is considered that the proper selection of control transistor used in the present invention should enable one or more parallel-connected LEDs to operate continuously for at least twice as long as the same LEDs operating from the same battery, but without any control circuit.

FIG. 4 also shows that the initial current supplied to the LEDs without the control circuit was 112 mA (80% of maximum LED capacity). However, when using the BD136 control transistor, the initial current was only 70 mA, (50% of maximum LED capacity), with no noticeable decrease in light output intensity. The control transistor implemented in accordance with aspects of the present invention therefore provides a significant degree of LED protection in the event of a power surge, or if the DC supply voltage is too high, by limiting the mA current drawn by the LEDs to values which are less than maximum rated values.

As seen in FIG. 4, after 15 hours of operation, the LEDs without the control circuit were operating below the 14 mA useful light output criterion (10% of maximum LED capacity). However, with the BD136 control transistor, after 15 hours of operation, the LED current was still at 32 mA (23% of maximum LED capacity) and the LED light output remained above the useful light output criterion for an additional 19 hours, for a total of 34 hours of continuous useful LED light output. With an improperly-selected control transistor, such as the PNP type 2N4403 transistor, the total LED operating time was only 24 hours. Hence, in addition to being portable, the process and apparatus of the present invention provide longer LED operating times in the order of 100% or more longer as compared to the operating time of a similar LED lamp assembly with the same battery but without the control circuit as provided in accordance with aspects of the present invention.

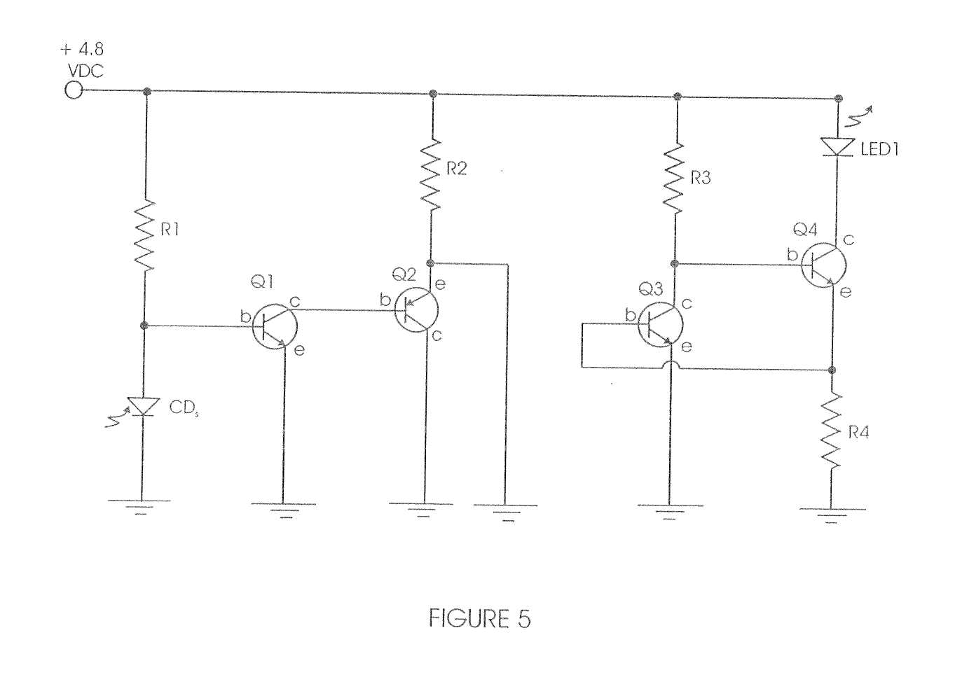

In another example, a white Luxeon LED (mounted on a metal substrate “Star” PCB heat sink for continuous operation) was fitted with an NX05 optical collimating lens to provide a rated light output of 200,000 millicandella at 20 degree viewing angle, with a 350 mA maximum current rating. As shown in FIG. 5, a different control circuit configuration provided in accordance with aspects of the present invention was utilized. The emitter and collector terminals of a suitable NPN control transistor Q4 were again connected in series with a suitable load resistor R4 across the power supply terminals. In this case, the white Luxeon LED is connected in series with a 4 ohm load resistor R4 at a suitable location along the emitter-collector-load resistor string, rather than in parallel with the load resistor, as in the control circuit previously described for use with a plurality of parallel-connected 5 mm white LEDs. The specific components and ratings as used for this embodiment of the control circuit are described below in Table 2:

TABLE 2
Components Used in the Control Circuit for a Single
White Luxeon LED

| Component | Description | Rating or Type |
|---|---|---|
| R1 | 80K | ½ watt |
| R2 | 9K | ½ watt |
| R3 | 1.2K | ½ watt |
| R4 | 4.0 ohms | 2 watt |
| Q1 & Q3 | 2N2222 | NPN transistor |
| Q2 | 2N4403 | PNP transistor |
| Q4 | MJE3055 | NPN transistor |
| CD | 1K to 20 Meg | cadmium sulfide photocell |
| LED1 | White Luxeon LED | maximum 350 mA |

It should be noted that FIG. 3 provides a complete control circuit while FIG. 5 only shows the circuit in sufficient detail so that an appropriate power supply can be connected for testing purposes. For purposes of simplicity, the battery, solar panel, DC jack and diode as shown in FIG. 3 are not included in FIG. 5. Resistors R1 through R4 as shown in FIG. 5 are conventional carbon-film resistors. The transistor Q1 acts in combination with cadmium sulfoselenide (cadmium sulfide) photocell sensor CD and resistor R1 to provide an on-off switching control that turns the Luxeon LED on at night and off in daytime.

At night, the resistance of the photocell CD is very high, i.e. about 20 meg-ohms, and causes the base voltage of the NPN transistor Q1 to be high, so the output at the collector of switching transistor Q1 is high, which provides a high voltage to the base of the PNP transistor Q2 so that the emitter output from the PNP transistor Q2 is turned on, causing the NPN trigger transistor Q3 to turn on the NPN control transistor Q4, which enables the white Luxeon LED to be turned on at night. During the daytime, the process is reversed, i.e. the resistance of the photocell is very low, i.e. about 1 K-ohms, causing the base voltage of the NPN transistor Q1 to be low, so the output at the collector of switching transistor Q1 is low, which provides a low voltage to the base of the PNP transistor Q2 so that the emitter output from the PNP transistor Q2 is turned off, causing the NPN trigger transistor Q3 to turn off the NPN control transistor Q4, which turns off the white Luxeon LED in the daytime.

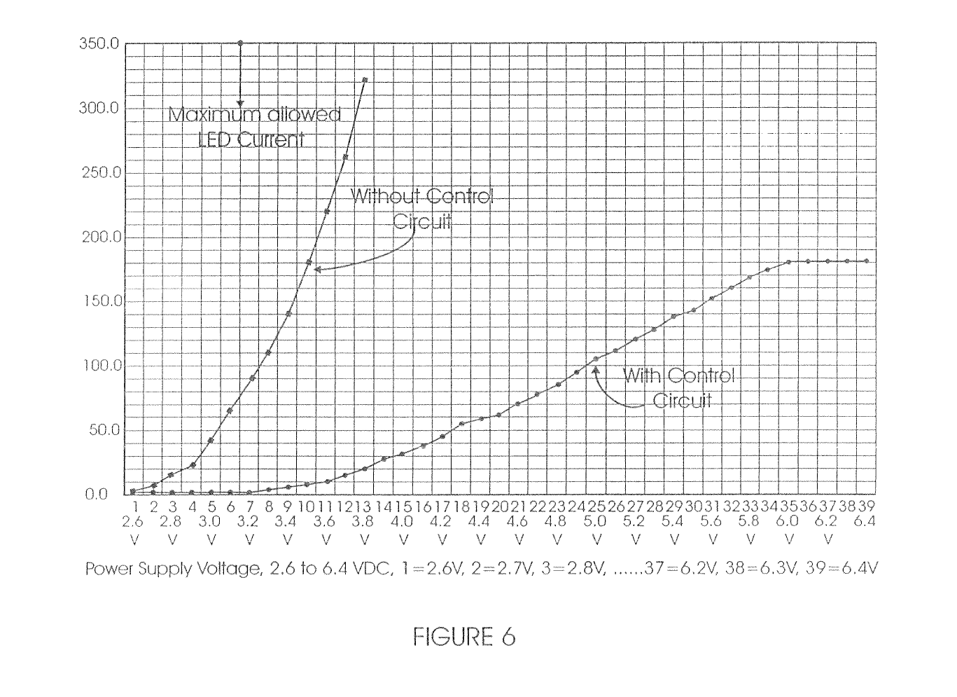

Using a stabilized power supply, this single Luxeon LED was tested with and without the control circuit of the present invention. The results are shown in FIG. 6, where the power supply voltage was varied from 2.6 VDC to 6.4 VDC. The control circuit of FIG. 5 is preferable operated from a NiMH battery pack with four cells connected in series, rated at 4.8 VDC and capable of operating between about 3.6 VDC and 5.6 VDC. Without the control circuit of the present invention. FIG. 6 shows that the white Luxeon LED can be operated only between about 3.6 VDC and 3.8 VDC, above which point the maximum current limit of 350 mA would be exceeded and the LED would burn out. FIG. 6 also shows that as DC supply voltage is increased above normal acceptable limits (i.e. beyond 5.6 VDC of a typical series-connected 4-cell NiMH battery pack), the control circuit of the present invention protects the white Luxeon LED from being burned out by leveling off the current consumption to less than about 180 mA when the supply voltage is increased beyond 5.6V.

With the control circuit of the present invention, FIG. 6 shows that the white Luxeon LED operates perfectly over the entire battery supply voltage range, from a battery supply minimum of 3.6 VDC (with 10 mA current consumption) up to a battery supply maximum of 5.6 VDC (with 150 mA current consumption). A 4-cell series-connected NiMH battery pack would normally be considered discharged below about 4.0 VDC. However at 4.0 VDC, the control circuit of the present invention still provides about 35 mA current to the white Luxeon LED. 35 mA (or 10% of maximum current rating) still provides the minimum useful light output threshold for this LED. Therefore, the control circuit of the present invention provides an almost completely linear current consumption response to changes in power supply voltage for the white Luxeon LED. Conversely, as illustrated in FIG. 6, the current consumption is very non-linear if the control circuit is not used.

As can be discerned from the graph of FIG. 6, significantly reduced power consumption when the LEDs are first turned on at relatively high battery supply voltages without any noticeable decrease in LED light output intensity is achievable using the process and apparatus of the present invention. This effect ensures that when the LEDs are operated from a fixed capacity power source, such as a battery, the LEDs can operate for a significantly longer duration with the control circuit of the present invention, as compared with LEDs operated without any control circuit, or LEDs operated with an improperly-selected control transistor.

The process and apparatus using the circuits provided in accordance with aspects of the present invention provide superior performance as compared to similar devices without the control circuits disclosed herein. Such dramatic improvements can be expressed in terms of (a) the duration of useful LED light output for LEDs that are operated from a fixed capacity power source (such as a battery), or (b) the decreased current requirements for a given level of LED light output. While the particular components, e.g., transistors, resistors, photocells, batteries, diodes, and LEDs, are described with specificity for forming the preferred circuits and lamp assemblies of the present invention, a person of ordinary skill in the art may substitute or vary one or more of the components to achieve the same goals. Accordingly, such changes are considered to fall within the spirit and scope of the present invention.

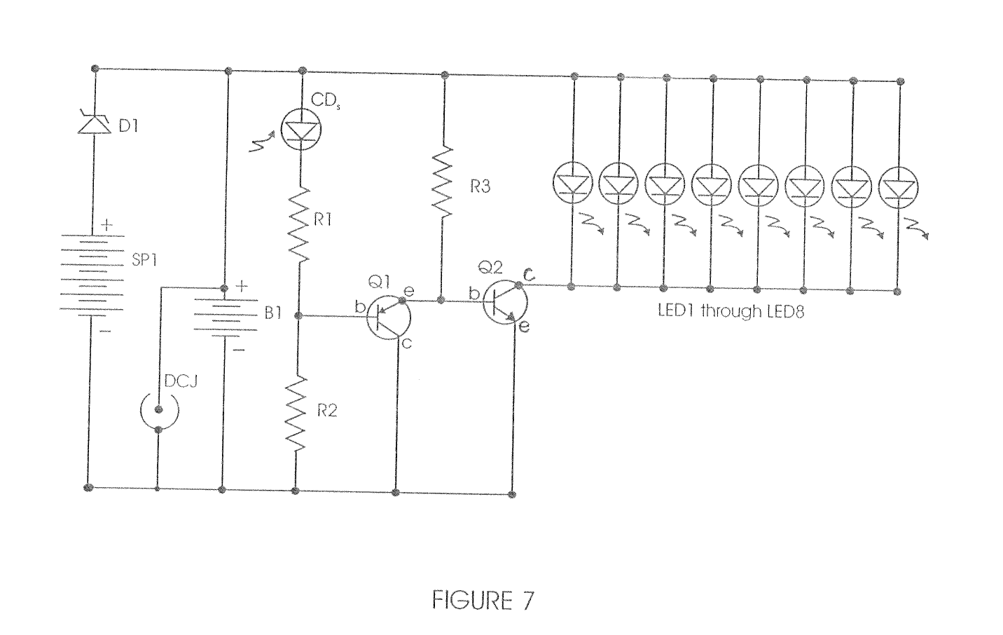

FIG. 7 provides another preferred control circuit configuration of the present invention, which uses a proprietary Darlington transistor as the control transistor Q2. A description of the circuit components for FIG. 7 are provided below in Table 3:

TABLE 3
Components Used in the Control Circuit of FIG. 7

| Component | Description | Rating or Type |
|---|---|---|
| R1 | 20K | ½ watt |
| R2 | 100K | ½ watt |
| R3 | 10K | ½ watt |
| D1 | SB340 | Schottky diode |
| Q1 | PNP type | switching transistor |
| Q2 | Proprietary type | Darlington control transistor |
| CDs | 2K to 100+K | cadmium sulfide photocell |
| DCJ | 2.1 × 5.5 mm | DC jack for solar panel plug |
| B1 | battery | 3.6 VDC @ 3000 mAh, NiMH type |
| SP1 | solar panel | maximum 7 VDC @ 500 mA |
| | | each LED rated 6000+ mcd @ 20 deg. |
| LED1 to | 5 mm white | angle @ 20 mA |
| LED8 | LEDs | |

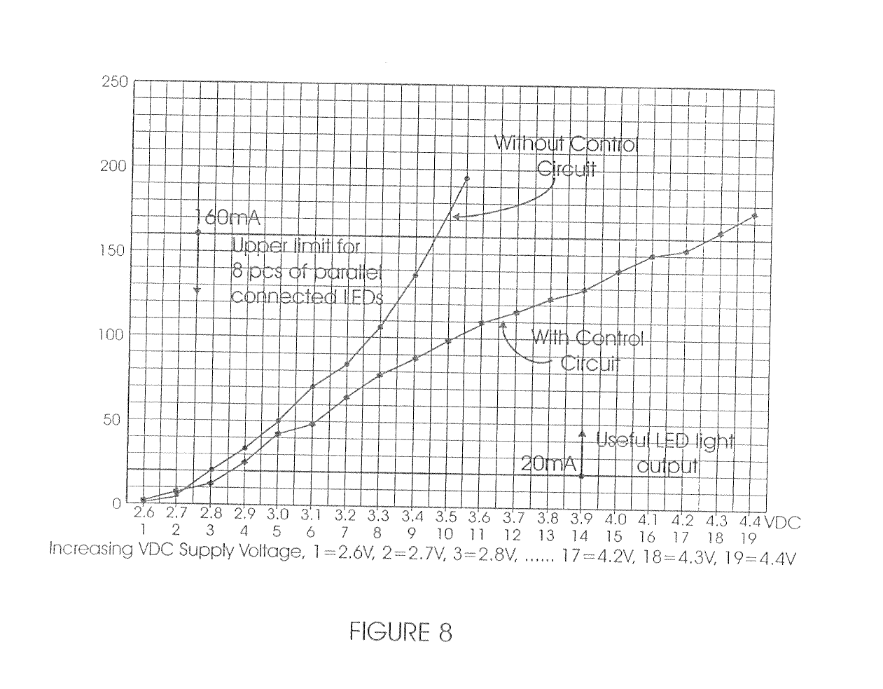

The resistors R1, R2 and R3 are preferably conventional carbon film resistors. The value of the resistor R3 is preferably selected according to the number and type of parallel-connected LEDs and generally ranges from 2K to 100K. At higher values of R3, the LEDs operate at reduced levels of light output, and at lower values of R3, the LEDs operate at elevated levels of light output. Proper selection of the resistor R3 assures that the proprietary Darlington control transistor Q2 provides sufficient but not excessive current to the parallel-connected LEDs over a relatively wide range of DC supply voltages, whether supplied from a battery or from other sources. This effect is described further in the following text as well as in FIGS. 8 & 9.

Schottky diode D1 minimizes the forward voltage drop penalty from the solar panel output voltage to the battery thereby maximizing the solar energy that can be used to recharge the nickel-metal hydride battery B1. The Schottky diode D1 also prevents the battery B1 from discharging backwards through the solar panel SP1 at night or in dim lighting conditions. The PNP switching transistor Q1 acts in combination with cadmium sulfoselenide (cadmium sulfide) photocell sensor CDs and resistor R2 to provide on-off switching control that turns the LEDs on at night and off in daytime. At night, the series resistance of the photocell CDs plus the resistor R1 is high, i.e. 100K or more, causing the base voltage of the PNP switching transistor Q1 to be low, causing a high emitter output from switching transistor Q1, which provides a high voltage to the base of the proprietary Darlington control transistor Q2, turning on the collector output from the proprietary Darlington control transistor Q2, causing the parallel-connected LED1 through LED8 to be turned on at night. During the daytime, the process is reversed, i.e. the resistance of the photocell CDs is very low. i.e. about 2 K, causing the base voltage of PNP switching transistor Q1 to be high, causing a low emitter output from switching transistor Q1, which provides a low voltage to the base of the proprietary Darlington control transistor Q2, turning off the collector output from the proprietary Darlington control transistor Q2, causing the parallel-connected LED1 through LED8 to be turned off during the daytime.

The battery B1 consists of 6 pcs of nickel-metal hydride (NiMH) “AA” size batteries each rated 1.2 VDC @1500 mAh, connected in a 2×3 array to provide a battery pack rated at 3.6 VDC @3000 mAh. These batteries can be recharged hundreds of times and the typical battery lifetime is about 5 years. The solar photovoltaic panel SP1 comprises 12 pcs of mono-crystalline silicon cells electrically connected in a 1×12 array to provide a maximum sunlight output rating of about 6.8 VDC @500 mA. These solar cells are mounted on an FR4 fiberglass substrate and are permanently bonded to a transparent glass front cover, thereby forming a waterproof, monolithic structure. A transparent bonding agent such as ethyl vinyl acetate (EVA, or “hot glue”) or transparent epoxy compound may be used to provide a waterproof mechanical seal with a high dielectric constant to electrically insulate the solar cells from each other. The DC power plug 50 at the end of the power cord from the solar panel (FIG. 1) can be plugged into the DC power jack DCJ suitably located on the lamp base of the portable LED lamp.

The emitter terminal of the proprietary Darlington control transistor Q2 is connected to the negative terminal of the battery B1. The parallel-connected LEDs LED1 through LED8 are suitably connected between the positive terminal of the battery B1 and the collector terminal of the proprietary Darlington control transistor Q2. As previously described, the proprietary Darlington control transistor and subsequently the LED system is turned on at night and off during the daytime by the PNP switching transistor Q1, which is controlled by the photocell sensor CDs.

The proprietary Darlington control transistor Q2, when operated with an appropriate value of resistor R3, optimizes the current consumption of the parallel-connected LEDs over a wide range of battery supply voltages. Different types of control transistor Q2 may be selected to provide optimum performance of one or more parallel-connected LEDs, with one preferred embodiment to provide an LED operating time at least twice as long as the same LEDs connected to the same battery, but without the control circuit of the present invention. As previously mentioned, resistor R3 may also be selected according to the number and type of LEDs as well as the LED electrical characteristics.

Experiments were conducted to evaluate the benefits of incorporating the control circuits provided in accordance with aspects of the present invention into a lamp, such as that shown in FIGS. 1 and 2, as compared with operating the same LEDs from the same battery but without any control circuit. In both tests, the same LED configuration was used, i.e. 8 pcs of 5 mm white LEDs, with a total light output rating of about 48,000 millicandella at 20 degree viewing angle, with a rated maximum current of 160 mA (i.e. 20 mA per LED). For purposes of evaluating the LED light output, it was determined that above a total current consumption criterion of about 20 mA (12.5% of maximum current), the light output from the 8 pcs of LEDs was considered to be useful for illuminating purposes. The tests were conducted using a regulated DC power supply system to measure current supplied to the 8 pcs of parallel-connected LEDs as a function of supply voltage.

The results of these tests are shown in FIG. 8, where it is immediately seen that the control circuit of the present invention allows the parallel-connected LEDs to operate with useful output light between about 2.9 VDC and 4.2 VDC, which comprises a somewhat wider range of supply voltages than would normally be expected from the nickel-metal hydride (NiMH) battery, nominally rated at 3.6 VDC. Conversely, without the control circuit of the present embodiment, the LEDs can operate only between a supply voltage range from about 2.8 VDC to a maximum of about 3.5 VDC. Therefore, the control circuit of the present invention protects the LEDs from being burned out even when the DC voltage supplied is about 20% higher (i.e. 4.2 VDC) than the maximum allowed without the control circuit (i.e. 3.5 VDC). For example, 4.2 VDC divided by 3.5 VDC is 1.20. This means that at a normal battery voltage of 3.6 VDC, the LEDs would be burned out due to excessive current consumption, unless the control circuit of the present invention is utilized.

FIG. 8 also shows that the proprietary Darlington control transistor Q2 regulates the current to the LEDs so that the LED current consumption is nearly linear with the supply voltage. This response characteristic of the control circuit tends to maximize the continuous operating time during which the LEDs provide useful output light when operating from a fixed-capacity battery. During such continuous LED operation, the battery becomes more and more discharged until no more useful LED output light can be produced. Therefore, an important feature of the control circuit of the present embodiment is to provide a nearly linear response between LED current consumption and LED supply voltage for a specific number and type of parallel-connected LEDs.

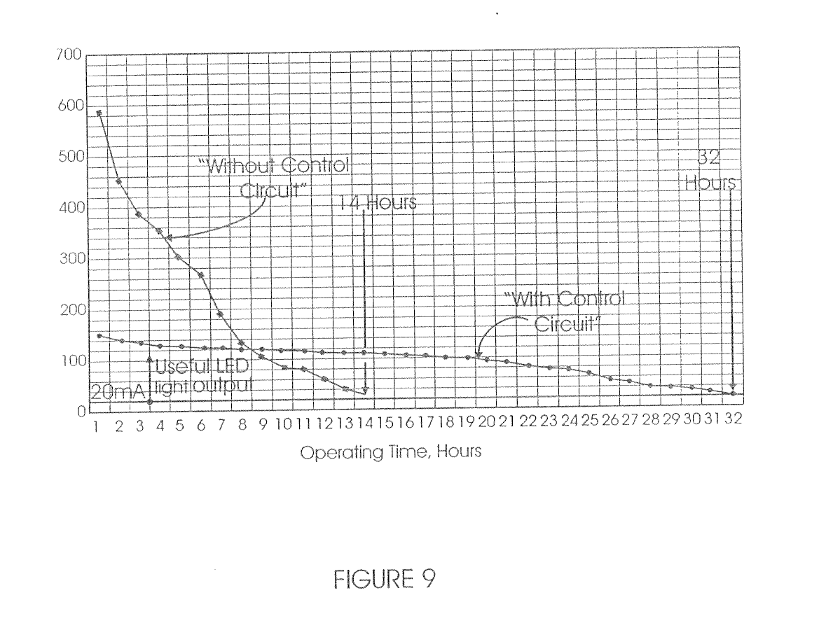

Additional tests were conducted to evaluate the effect of the control circuit on the number of hours that 8 pcs of white 5 mm parallel-connected LEDs continued to operate from a fully-charged battery, rated 3.6 VDC at 3000 mAh capacity. The results are shown in FIG. 9, where it is immediately seen that without the control circuit, the LEDs produce useful light for only 14 hours of continuous operation. But with the control circuit, the duration of LED useful light output was increased by about 230% to 32 hours. Once again, the control circuit of the present embodiment provided continuous LED operation for more than double the LED operating time with the same LEDs operating from the same battery, but without the control circuit.

It has ready been noted that the parallel-connected LEDs would burn out if operated directly from a fully-charged 3.6 VDC battery. Therefore, the current consumption for the case without the control circuit in FIG. 9 was calculated from a starting voltage of 4.1 VDC, down to 3.5 VDC. The fully-charged battery was discharged down to 3.5 VDC, at which point tests were conducted from the 3.5 VDC level down to about 2.9 VDC to provide test data. The combination of calculation plus test data for the “without control circuit” curve in FIG. 9 is compared with test data for the “with control circuit” curve. The area under the two curves in FIG. 9 represent the battery capacity in milliamp-hours (mAh). If these areas are measured, the result is 3020 mAh for the “without control circuit” and 3000 mAh for “with control circuit”. Therefore, a direct comparison of the results is considered justified.

These unique and surprising results show that selecting an optimum type of control circuit for a specific parallel-connected LED configuration can provide dramatic improvements in the LED light output performance. Such dramatic improvements can be expressed in terms of (a) the duration of useful LED light output for parallel-connected LEDs that are operated from a fixed capacity power source (such as a battery), or (b) providing a nearly linear response between LED current consumption and LED supply voltage for a specific number and type of parallel-connected LEDs. In addition, it has also been shown that that control circuit also acts to protect the LEDs from being burned out even when the supply voltage exceeds the danger level by as much as 20%.

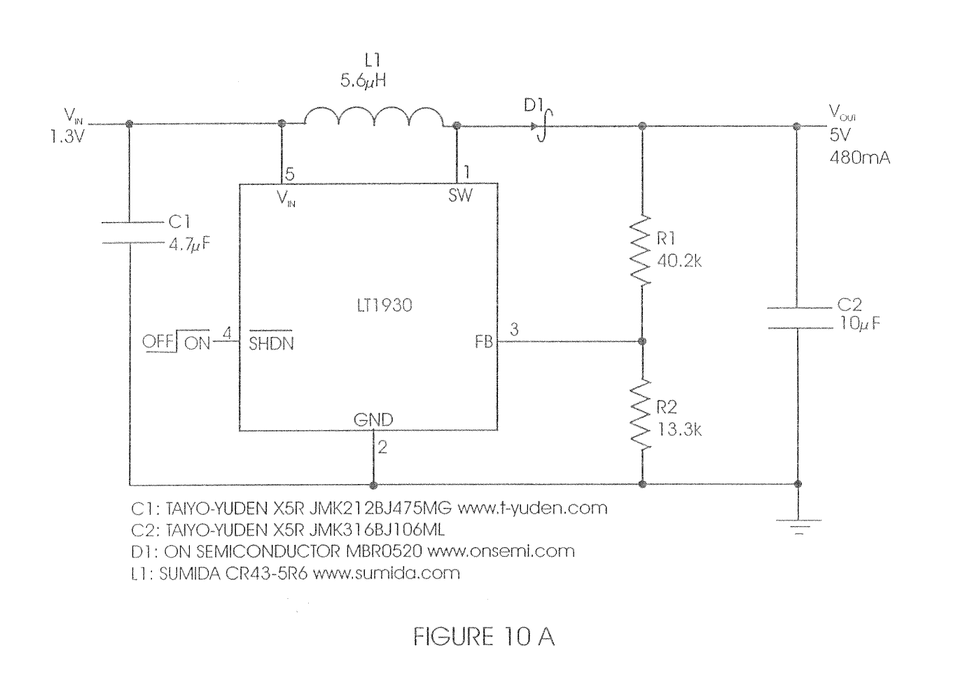

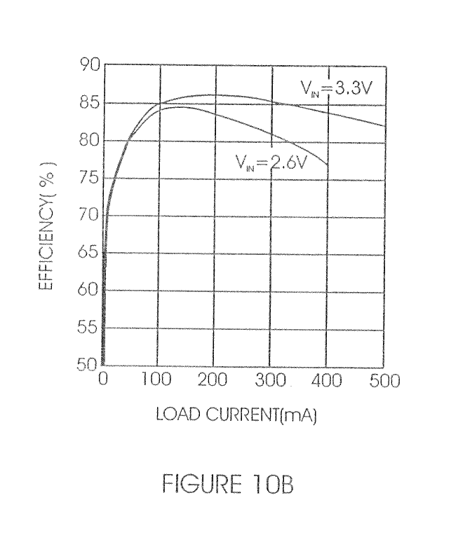

FIG. 10A provides details about a DC converter (e.g., DC converter 64, FIGS. 2B and 2C) useable to increase a variable input DC voltage from the battery located inside the lamp to provide a regulated DC output voltage to the output connector (e.g., connector 66, FIG. 2C) of an OAD. The circuit shown in FIG. 10A utilizes an integrated circuit (IC) ceramic metal-oxide semiconductor (CMOS) chip to provide the regulated DC output voltage, which can be set at any desired level, such as 5 VDC or 12 VDC, based on battery input supply voltage from a minimum of 2.6 VDC to a maximum of about 4.1 VDC. The IC CMOS chip operates at high frequency, generally 200 KHz to as high as 2.2 megahertz or more. The specific IC CMOS chip shown in FIG. 10A is a P/N 1930 available from Linear Technology Corporation, operating at 1.2 megahertz. Obviously, other types of IC CMOS chips and/or other types of battery supply voltage ranges could be selected, with similar results being obtained, i.e. the ability to provide a regulated DC output voltage at any desired level.

As shown in FIG. 10A, the desired DC output voltage level is adjusted by changing the resistors R1 and R2. Curves showing the efficiency of the LT 1930 IC CMOS chip versus current demand for various levels of battery supply voltage is provided in FIG. 10B. As can be seen, the IC CMOS chip provides DC voltage conversion efficiencies generally higher than 80%.

One preferred embodiment of the regulated DC output accessory that provides 5 VDC output was tested in combination with the battery and control circuit schemes of the present invention. The tests were conducted with an older AM/FM cassette tape player, a Sony Walkman Model No. WM-F2015, which operates at a nominal voltage of 3.0 VDC using two (2) AA cells. Two nearly-dead NiMH AA cells (normally rated 2.4 VDC) were installed for this test. The measured voltage from these two cells was less than 0.10 VDC. At the start of the test, with no load, the voltage of the battery 14 in the lamp base 20 was 4.04 VDC. The 5 VDC adapter charger was plugged into the lamp base 20 using the DC plug 62 connected to DC jack 52. The output from the 5 VDC adapter charger was 5.20 VDC with no load and 5.24 VDC with 114 mA load when the Sony Walkman tape player was running. The Sony Walkman tape player played for about 60 minutes, which is equivalent to a battery capacity consumption of about 150 mAh based on 80% efficiency of DC convener 64. After about 60 minutes of operation, the NiMH batteries were charged to 1.1 VDC each (2.2 VDC in series), and the voltage of the battery 14 inside the lamp base 20 had dropped from 4.04 VDC down to 3.92 VDC. The 5 VDC Adapter Charger seems to work perfectly for operating hand-held electronic devices such as a Sony Walkman, a Nintendo Game Boy electronic games, personal desktop assistants (PDAs) such as Palm Pilot, etc.

Another preferred embodiment of the regulated DC output accessory that provides 12 VDC output was tested in combination with the battery and control circuit schemes of the present invention, e.g., with the lamp 12 of FIGS. 1 and 2. The tests were conducted with an Audiovox Digital 1X cell phone, Model No. AUD-9100 with Lithium-Ion rechargeable battery rated 3.6 VDC @900 mAh. At the start of the test, the battery status indicator on the cell phone showed the battery at ⅓ charge (non-linear scale). At the start of the test, with no load, the voltage of the battery 14 in the lamp base 20 was 3.92 VDC. The 12 VDC Adapter Charger was plugged into the lamp base 20 using the DC plug 62 connected to the DC jack 52. With no load, the output from the 12 VDC Adapter Charger was 12.2 VDC. The output connector 66 was a female 12 VDC cigarette adapter socket, as similarly shown in FIG. 2C. The male 12 VDC cigarette adapter supplied with the Audiovox cell phone was then plugged into the female 12 VDC cigarette adapter provided with the 12 VDC adapter charger being tested.

At the beginning of the test, the 12 VDC adapter charger provided 335 mA of charging current, which decreased in a non-linear fashion to about 90 mA of charging current after about 60 minutes of continuous charging. At the end of the test, after about 60 minutes, the voltage of the battery 14 in the lamp base 20 had dropped to about 3.0 VDC and the battery status indicator on the cell phone showed full charge (3/3 status). The efficiency of the DC converter 64 is not as high when providing 12 VDC output as when providing 5 VDC output. The cell phone battery rated at 900 mAh had a capacity of about 300 mAh at the start of the test and was fully charged at the end of the test. The 12 VDC adapter charger therefore provided about 600 mAh to the cell phone battery, using the 12 VDC cell phone charger provided with the cell phone, which also operates at less than 100% efficiency. It is assumed that the 12 VDC cell phone charger operates at about 25% efficiency and the 12 VDC adapter charger of the present invention operates at about 75% efficiency. Using these numbers, the capacity of the battery 14 in the lamp base 20 was depleted by about 2000 mAh. Since the battery 14 has a total capacity of 3000 mAh, and since the first test using the 5 VDC adapter charger consumed about 150 mAh, the remaining battery capacity after the second test was estimated to be about 850 mAh. This expectation was verified by operating the 8 pcs of white 5 mm LEDs contained in the portable LED lamp assembly for an additional 12 hours after the second test.

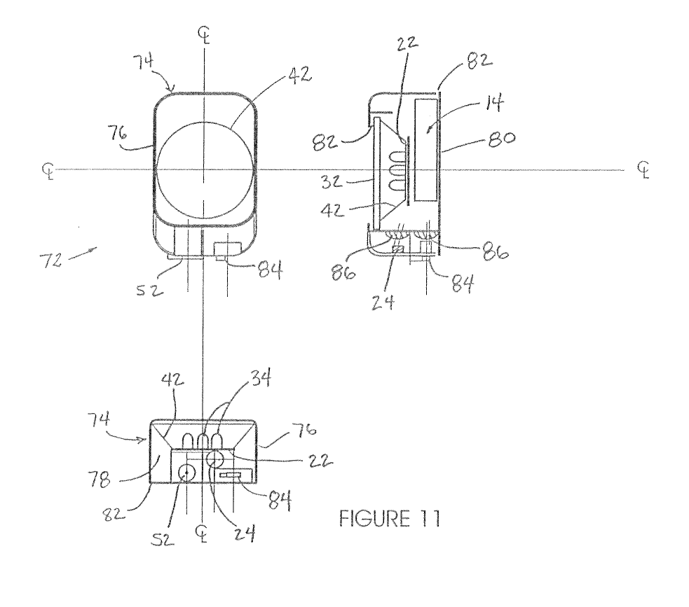

FIG. 11 illustrates different views of a an alternative lamp assembly 72 provided in accordance with aspects of the present invention comprising a lamp 74 having a housing 76 for containing components, such as LEDs 34 and a PCB 22. Not shown in FIG. 11 but understood to be part of the lamp assembly 72 of FIG. 11 are related components including a small solar photovoltaic panel having a power cord, and a DC plug for recharging the battery located inside the housing 76.

Similar to the lamp assembly 10 of FIGS. 1 and 2, in the present lamp assembly 72, the battery 14 is contained in the housing 76 of the portable lamp 74 and supplies electrical energy to the PCB-mounted control circuit 22, also located in the housing, which is in turn regulated by the photocell sensor 24 located at a side 78 of the housing 76. In one preferred embodiment, the lamp housing 76 is permanently bonded to the back cover 80 by means of ultrasonic welding the plastic materials to form a waterproof seal around the battery 14 and the other components, such as the LEDs 34 and the PCB 22, which contains a control circuit provided in accordance with aspects of the present invention.

The LEDs 34 are preferably contained within a suitable reflector 42, which can be silver-coated plastic or glass, or shaped aluminum metal. The lamp housing 76 is preferably constructed to be waterproof or water resistant as the front lens 32 is also permanently bonded to said lamp housing 76 by means of ultrasonic welding the plastic materials. Ultrasonic welding, or acoustic welding, is preferably conducted at between about 20 kHz to 40 kHz. The frequency range produces sound energy sufficient to cause the plastic materials to melt together at the melt zones 82 to thereby seal the different components together to form a waterproof or water resistant lamp 74. Such sound energy is preferably transmitted through one or more properly-designed energy directors, which are preferably injection-molded onto the surfaces of melt zones 82 of the plastic parts to be permanently bonded together. The front lens 32 is preferably transparent or translucent to allow light emanating from the LEDs 34 to pass through the front lens for illumination purposes.

Several components are preferably located outside the waterproof housing 76, such as the DC jack 52, the cadmium sulfide photocell sensor 24, and the on-off switch 84, which are preferably located for convenient access on the sidewall 78 of the lamp housing 76. The manually-operated on-off switch 84 disconnects the battery 14 from the control circuit 22 to maintain battery capacity during storage, shipping, or periods of non-use. Electrical wires from the components located outside the waterproof zone provided by the waterproof housing 76 pass through ports or holes in the waterproof housing and room temperature vulcanized (RTV) silicone sealant 86 (or other suitable flexible waterproof sealant) is preferably used to insure proper waterproofing of these electrical wire penetrations.

In one exemplary embodiment, the alternative lamp 74 is relatively small having a dimension of about 48×70 mm by 30 mm high and is preferably lightweight (about 80 grams, including a single AAA battery, NiMH type, rated 3.6V @750 mAh). In one preferred embodiment, the small LED lamp 74 operates with 3 pcs of 5 mm white LEDs and runs for about 10 to 12 hours on a fully-charged 3.6V battery rated 750 mAh. The solar panel (not shown), which is preferably used to recharge the battery, is also preferably small and lightweight, in the order of about 50×120 mm in size and weighing only about 35 grams. Such a small solar photovoltaic panel can provide, in one preferred embodiment, about 5.8 VDC @120 mA in full sunlight.

The size and weight of the lamp assembly 72 of FIG. 11 allows the lamp components to easily be mounted to almost any surface using Velcro® material with outdoor-rated sticky-back surfaces. For example, in one preferred embodiment, the LED lamp 74 and/or the small solar panel (not shown) have one component of the Velcro® material (preferably the “hooked” component) mounted on the flat back side 80 of the LED light 74 or the flat back side of the solar panel. The LED light 74 and/or the solar panel (not shown) can then preferably be securely mounted to almost any surface by first attaching the felted component of the Velcro® material to the desired surface either using the sticky-backing or by sewing, riveting or otherwise attaching the felted material to the mounting surface. This preferred method of mounting LED assembly 72 of the present invention would enable the small portable LED light 74 and/or the small solar panel (not shown) to be securely mounted to a hat, tent, backpack, wall, roof, window, dashboard, picnic table, saddle, canoe, kayak, or almost any surface using such Velcro® materials. Such preferable mounting flexibility using Velcro® materials enables the small LED light 74 as described above and in FIG. 11 to provide highly desirable LED illumination for a variety of possible applications which are too numerous to identity in this description. Other methods of mounting small portable LED lamps as described herein include conventional mounting with hooks, screws or nails, headband mounting using an elastic headband, so the LED lamp provides illumination in whichever direction the user's head is turned, or mounting with various types of glue or sealants.

### LED Waterproofing and Mounting

As discussed above, waterproofing the LEDs and the control circuit of the present invention is desirable for long term operation in applications involving wetness or moisture to prevent short-circuit and/or corrosion of various electrical parts, that would cause the LEDs to stop working properly. Various methods of waterproofing can be used, including but not limited to systems which mechanically-compress an “O” ring to provide a waterproof seal, acoustic welding of a plastic LED enclosure, using a flexible enclosure around the LEDs, such as silicone rubber, sealing any required wire connection penetrations with flexible compounds such as silicone sealant, and/or combinations of the above. However, the LED lamp assemblies discussed elsewhere herein will operate in the absence of waterproofing.

Various methods of mounting the LEDs and making the connections to the control circuit of the present invention are also required for long-term reliability so the LEDs continue to work properly. Various methods of LED mounting can be used, including but not limited to systems which use mechanical screws to hold down the LEDs mounted on a suitable PCB substrate, to hold down LEDs already provided with mounting means such as a plastic enclosure, acoustic welding one or more LEDs inside a suitable plastic enclosure with a transparent front lens, mounting small-sized LED lights using Velcro® materials to attach LED lighting components securely to almost any surface, mounting the LEDs inside glass or plastic reflectors, such as MR11 or MR16 glass reflectors with dichroic silver coating, and/or combinations of the above.

### Description of Alternative Power Sources

In the examples described above, various types of power supplies can be used with the control circuit of the present invention to provide superior LED performance characteristics. There are a wide variety of alternative power sources that could be utilized with the present invention. These include almost any type of external power source, AC or DC, which can be easily converted to an appropriately regulated source of DC power to be supplied to the control circuit of the present invention for driving most types of parallel-connected LEDs.

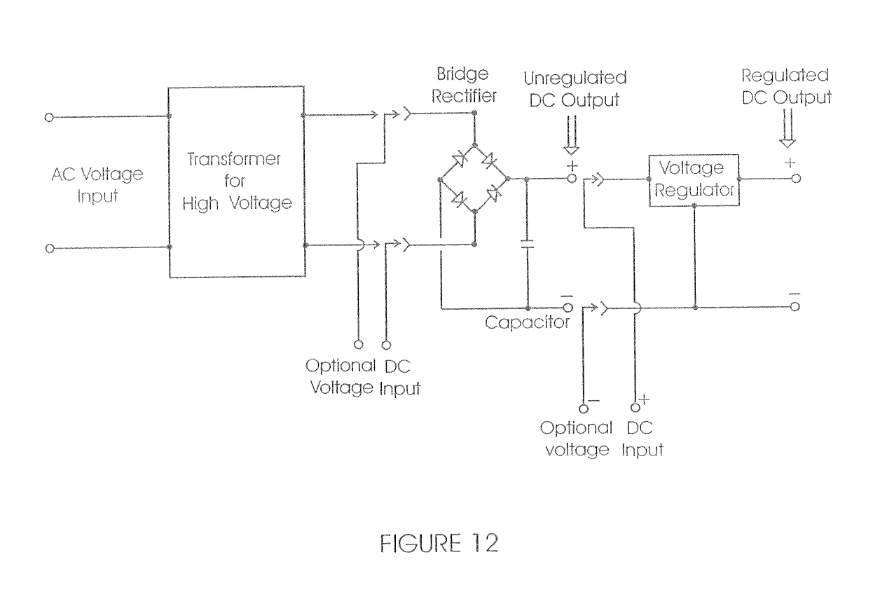

For example, the components shown in FIG. 12 provide a clear illustration of preferred embodiments for power supply systems of the present invention, which are supplied with external sources of either AC or DC power. High voltage AC power is preferably reduced to lower voltages using simple iron-core transformers or high frequency miniature electronic transformers. The output from the optional transformer is then preferably rectified to DC using a suitable bridge rectifier, consisting of 4 pcs diodes such as 1N4001 or 1N5817. The output from the bridge rectifier is then preferably smoothed with a capacitor to provide an unregulated DC output voltage. It should be noted that in one preferred embodiment, DC voltage of any polarity can be supplied at the input of the bridge rectifier, with a small voltage drop taking place at the unregulated DC voltage output terminals due to the forward voltage drop from the bridge rectifier diodes.

The unregulated low voltage DC power supply can preferably be supplied to a suitable DC plug, such as the battery charging input connector 70 as shown in FIG. 2B. The unregulated DC voltage output can preferably be used to recharge a battery, provided that the current capacity of the DC supply is not so high that the battery would become overheated from overcharging. Typically, if the DC supply capacity is limited to less than about 10% or 20% of the battery capacity, battery overheating from overcharging should not take place. For example, recharging with less than about 100 mA or 200 mA DC current being supplied to a 1000 mAh capacity battery will typically not cause overheating from overcharging, regardless how long the charging current is connected to the battery. A battery is preferably sized to act as a simple voltage regulator, to prevent excessive DC voltage from being supplied to the control circuit of the present invention.

In order to provide appropriate DC voltage directly to the control circuit of the present invention when not using a battery, a voltage regulator is preferably utilized to provide DC voltage at the correct level. Simple DC voltage regulators are preferably utilized. These consist of integrated circuit (IC) ceramic metal oxide semiconductor (CMOS) components that typically can accept voltages up to about 30 VDC, and provide voltage regulation down to 5 VDC with a DC current supply capacity of 1.0 amp or more. One preferred type of voltage regulator used for this purpose is designated LM7805.

When considering various types of battery power sources, the types which are most preferably for use with the present invention are rechargeable, including but not limited to nickel-cadmium (NiCd), nickel-metal hydride (NiMH), sealed gel cell lead-acid, or lithium-ion (Li-Ion). Such types of rechargeable batteries are perfectly suitable for use with solar photovoltaic panels, either mono-crystalline silicon or multi-crystalline silicon type. Such solar cells are preferably mounted on fiberglass FR4 substrate or other suitable substrate to provide mechanical strength. The solar panels for use with the present invention are preferably protected with a waterproof surface coating, which may be selected from materials such as glass. Tedlar® or Tefzel®. Whichever surface coating is utilized, it is preferably bonded to the solar panel using ethyl vinyl acetate (i.e. EVA, or “hot glue”) or transparent epoxy compound, to provide a monolithic and physically-robust structure for the solar photovoltaic panel, which is preferably weatherproof and transparent, thus enabling efficient capture of solar energy.

There are also a variety of fuel cells presently being developed, which will soon become commercially available. For example, micro fuel cells using proton exchange membranes (PEMs) or porous ceramic substrates have been under development using methanol-water mixtures and/or similar mixtures with other alcohols. This process, called the direct methanol fuel cell (DMFC) was first described by the University of California Jet Propulsion Laboratory in 1996. Several companies have announced successful initial testing of DMFC micro fuel cells to be used for laptop computers and/or cell phones, and commercial release is expected in the near future. If these types of fuel cell were to be substituted for the rechargeable battery and solar panel system, the DMFC micro fuel cell could preferably be “recharged” by injecting small amounts of methanol or other alcohol mixtures as might be required after at periodic intervals of DMFC fuel cell use.

Other types of fuel cells also under development utilize gaseous hydrogen carried into the PEM fuel cell system using air or oxygen as a carrier gas. Since safe storage of gaseous hydrogen at low pressures presents several technical problems which have not yet been solved, the DMFC type of fuel cell is preferable for LED lighting applications in the near term. However, research and development of technology to provide very high surface-to-volume ratio materials (typically greater than 500,000 per ft, or 1,000,000 per ft), such as sintered metal hydride and/or carbon nanotubes. Such materials offer potential for surface storage of hydrogen gas under very safe conditions at low pressures and temperatures. Such hydrogen storage improvements might eventually provide alternatives to very high pressure storage of gaseous hydrogen for use in fuel cells. Therefore, PEM fuel cells using gaseous hydrogen stored on the surfaces of such advanced materials may also become a preferred source of electrical energy for use with the control circuit and LED lighting systems of the present invention.

Although the preferred embodiments of the invention have been described with some specificity, the description and drawings set forth herein are not intended to be delimiting, and persons of ordinary skill in the art will understand that various modifications may be made to the embodiments discussed herein without departing from the scope of the invention, and all such changes and modifications are intended to be encompassed within the appended claims. Various changes to the lamp assemblies and circuits disclosed herein may be made including different configurations and/or dimensions, manufacturing differently, using different materials, using different mechanical fastening means, etc. Accordingly, many alterations and modifications may be made by those having ordinary skill in the art without deviating from the spirit and scope of the invention.

What is claimed is:

1. A method for regulating current over a wide range of voltage supply levels being provided to two or more continuously operating parallel-connected light-emitting diodes (LEDs) comprising: determining a minimum current threshold for providing useful LED output light; providing a control circuit comprising at least one control transistor between a fixed capacity power supply and the two or more continuously operating LEDs; and wherein said control circuit enables said LEDs to provide useful output light above said minimum current threshold for a continuous operating time which is at least twice as long as the condition wherein a control circuit has not been installed.

2. The method as recited in claim 1, wherein the two or more continuously operating LEDs comprises at least three continuously operating LEDs, and wherein the at least three continuously operating LEDs are connected in parallel.

3. The method as recited in claim 1, wherein the fixed-capacity power supply is selected from the group consisting of nickel-cadmium (NiCd) batteries, nickel-metal hydride (NiMH) batteries, lead-acid batteries, sealed gel-cell lead acid batteries, lithium-ion (Li-Ion) batteries, proton exchange membrane (PEM) fuel cells, direct methanol fuel cells (DMFC), and combinations thereof.

4. The method as recited in claim 1, wherein the control transistor used in said control circuit is selected to provide twice the LED continuous operating time compared with the operating time for the same two or more continuously operating LEDs operating from the same fixed-capacity power supply without the control circuit.

5. The method as recited in claim 3, further comprising the step of recharging the fixed-capacity power supply with electrical energy, which is obtained from a solar photovoltaic panel, from an external source of AC power, from an external source of DC power, such as a fuel cell, by adding gaseous hydrogen, or by adding hydrogen-containing compounds in a non-gaseous form.

6. The method as recited in claim 1, further comprising the step of protecting said two or more continuously operating LEDs from being burned out whenever the DC voltage supplied to the control circuit exceeds a maximum forward voltage rating for the one or more continuously operating LEDs by at least about 20%.

7. The method as recited in claim 1, wherein a photocell sensor is used in combination with a bias resistor and a switching transistor to adjust a base voltage of the control transistor in the control circuit to turn off the two or more continuously operating LEDs in the daytime and turn on the one or more continuously operating LEDs during low ambient lighting conditions.

8. A method for operating an assembly comprising one or more parallel-connected non-blinking LEDs and a fixed capacity battery, comprising:
installing at least one of a control transistor and a control circuit between the fixed capacity battery and the one or more LEDs,
establishing a minimum mA current threshold for providing continuous useful output light from one or more LEDs, said minimum mA current threshold supplied from the fixed capacity battery,
charging the fixed capacity battery to its rated maximum mA-hour capacity and operating the assembly to determine a continuous LED operating time of the assembly during which the one or more LEDs operate above said minimum mA current threshold, said one or more LEDs producing useful output light while consuming at least about 60% of the maximum mA-hour capacity of the fixed capacity battery and continuing to operate above said minimum mA current threshold, and
wherein the continuous LED operating time is at least twice as long as the same assembly powering the same at least one or more LEDs but without installing at least one of a control transistor and a control circuit between the fixed capacity battery and the one or more LEDs.

9. The method as recited in claim 8, wherein the control circuit comprises a Darlington type control transistor.

10. The method as recited in claim 8, wherein the fixed capacity power supply is a battery which may be recharged using a solar photovoltaic panel, an external source of direct current electrical energy, or direct current electrical energy which is derived from an external source of alternating current electrical energy.

11. The method as recited in claim 8, wherein the fixed capacity power supply is a rechargeable battery.

12. The method as recited in claim 8, wherein a photocell sensor is used in combination with a bias resistor to adjust an output from a switching transistor to control a voltage supplied to a base of the control transistor, wherein the one or more LEDs are automatically turned off in the daytime and automatically turned on at night or in dim ambient lighting conditions.

13. The method as recited in claim 8, wherein the control transistor is selected to optimize performance of a specific number, type, and configuration of the one or more LEDs to provide continuous and useful LED output light while protecting said one or more LEDs from being burned out, even if the DC voltage supplied to said control circuit exceeds a maximum forward voltage of the one or more LEDs by at least about 20%.

14. The method as recited in claim 8, wherein the control transistor is selected for optimized performance determined by maximizing the duration of continuous and useful LED output light obtained from a specific number and type of parallel-connected continuously operating LEDs.

15. The method as recited in claim 11, wherein the rechargeable battery is selected from a group consisting of nickel-metal hydride battery, lithium-ion battery, or sealed lead-acid gel cell battery.

16. The method as recited in claim 15, wherein the rechargeable battery is rechargeable using a solar photovoltaic panel, an external charger adapter deriving DC power from an AC power source, a DC power source, or any combination thereof.

17. The method as recited in claim 8, wherein said one or more LEDs producing useful output light while consuming at least about 70% of the maximum mA-hour capacity of the fixed capacity battery and continuing to operate above said minimum mA current threshold.

18. The method as recited in claim 8, wherein said one or more LEDs producing useful output light while consuming at least about 80% of the maximum mA-hour capacity of the fixed capacity battery and continuing to operate above said minimum mA current threshold.

19. A method for operating an assembly comprising one or more parallel-connected non-blinking LEDs and a fixed capacity battery, comprising:
installing at least one of a control transistor and a control circuit between the fixed capacity battery and the one or more LEDs,
determining a minimum mA current threshold for providing continuous useful output light from the one or more parallel-connected non-blinking LEDs, said minimum mA current threshold supplied from the fixed capacity battery,
charging the battery to the rated maximum mA-hour capacity and operating the assembly to determine the continuous LED operating time of the assembly during which the one or more parallel-connected non-blinking LEDs provide useful output light while operating above said minimum mA current threshold and consuming at least about 55% of the maximum mA-hour capacity of the fixed capacity battery, and
maximizing the continuous LED operating time of the assembly during which the one or more parallel-connected non-blinking LEDs provide useful output light while operating above said minimum mA current threshold to at least twice as long as the same assembly without at least one of a control transistor and a control circuit between the fixed capacity battery and the one or more parallel-connected non-blinking LEDs.

20. The method as recited in claim 19, wherein the one or more parallel-connected non-blinking LEDs comprise at least three continuously operating LEDs, and wherein the at least three continuously operating LEDs are connected in parallel.

21. The method as recited in claim 19, wherein the fixed capacity battery is selected from a group consisting of nickel-cadmium (NiCd) batteries, nickel-metal hydride (NiMH) batteries, lead-acid batteries, sealed gel-cell lead acid batteries, lithium-ion (Li-Ion) batteries, proton exchange membrane (PEM) fuel cells, direct methanol fuel cells (DMFC), and combinations thereof.

22. The method as recited in claim 19, wherein the control circuit comprises a Darlington type control transistor.

23. The method as recited in claim 19, further comprising the step of protecting said one or more parallel-connected non-blinking LEDs from being burned out whenever a DC voltage supplied to the control circuit exceeds a maximum forward voltage rating for the one or more parallel-connected non-blinking LEDs by at least about 20%.

24. The method as recited in claim 19, wherein a photocell sensor is used in combination with a bias resistor and a switching transistor to adjust a base voltage of the control transistor in the control circuit to turn off the one or more parallel-connected non-blinking LEDs during daytime and turn on the one or more continuously operating LEDs during low ambient lighting conditions.

25. The method as recited in claim 19, wherein the one or more parallel-connected non-blinking LEDs provide useful output light while operating above said minimum mA current threshold and consuming at least about 65% of the maximum mA-hour capacity of the fixed capacity battery.
